(19) United States
(12) Patent Application Publication
(10) Pub. No.: US 2025/0259594 A1
(43) Pub. Date: Aug. 14, 2025

(54) DISPLAY PANEL AND DRIVING METHOD THEREFOR

(71) Applicant: Yungu (Gu’an) Technology Co., Ltd., Langfang (CN)

(72) Inventors: Lei MI, Langfang (CN); Cuili GAI, Langfang (CN); Lan LAN, Langfang (CN); Xuejie MA, Langfang (CN)

(73) Assignee: Yungu (Gu’an) Technology Co., Ltd., Langfang (CN)

(21) Appl. No.: 19/074,421

(22) Filed: Mar. 9, 2025

(30) Foreign Application Priority Data
Mar. 27, 2024 (CN) 202410361807.1

(51) Int. Cl. G09G 3/3225

(52) U.S. Cl. CPC G09G 3/3225; G09G 2300/0426; G09G 2310/08; G09G 2320/0247; G09G 2340/0457

(57) ABSTRACT

The present application discloses a display panel and a driving method therefor, and a display apparatus. The display panel includes a pixel circuit and light-emitting element groups, where one light-emitting element group includes N light-emitting elements, all first electrodes of the N light-emitting elements are electrically connected to an output terminal of the same pixel circuit, and the N light-emitting elements are located in different rows and emit light in different time periods within one frame.

### CROSS-REFERENCE TO RELATED APPLICATIONS

The present application claims priority to Chinese Patent Application No. 202410361807.1, entitled “DISPLAY PANEL AND DRIVING METHOD THEREFOR, AND DISPLAY APPARATUS” and filed on Mar. 27, 2024, the entire contents of which are incorporated herein by reference.

### FIELD

The present application relates to the field of display technologies, and in particular, to a display panel and a driving method therefor, and a display apparatus.

### BACKGROUND

Organic light emitting diodes (OLEDs) and flat panel display apparatuses based on technologies such as light emitting diodes (LEDs) have been widely used in various consumer electronics such as mobile phones, televisions, notebook computers, and desktop computers and predominate in display apparatuses due to their advantages such as high image quality, energy efficiency, slim design, and a wide application range.

However, the display performance of current OLED display products still needs improvement.

### SUMMARY

Embodiments of the present application provide a display panel and a driving method therefor, and a display apparatus, to solve the problems of a limited way of light emission, poor flexibility, and a small range of use scenarios in the prior art.

According to one embodiment of the present application provides a display panel. The display panel includes:
a pixel circuit and light-emitting element groups, where one light-emitting element group includes N light-emitting elements, and all first electrodes of the N light-emitting elements are electrically connected to an output terminal of the same pixel circuit; and
the N light-emitting elements are located in different rows and emit light in different time periods within one frame, where N is an integer greater than 1.

According to one embodiment of the present application further provides a driving method for a display panel. The display panel includes a pixel circuit and light-emitting element groups, where one light-emitting element group includes N light-emitting elements, and all first electrodes of the N light-emitting elements are electrically connected to an output terminal of the same pixel circuit; and
the N light-emitting elements are located in different rows and emit light in different time periods within one frame, where N is an integer greater than 1; and
the driving method includes:
controlling the N light-emitting elements located in different rows to emit light in different time periods within one frame.

In one embodiment, the driving method further includes:
within the first time period, controlling the light-emitting element located in an odd-numbered row to emit light; and within the second time period, controlling the light-emitting element located in an even-numbered row to emit light.

In one embodiment, the driving method further includes:
within the first time period, controlling the light-emitting element located in both an odd-numbered row and an odd-numbered column to emit light, and controlling the light-emitting element located in both an even-numbered row and an even-numbered column to emit light; and within the second time period, controlling the light-emitting element located in both an odd-numbered row and an even-numbered column to emit light, and controlling the light-emitting element located in an even-numbered row and an odd-numbered column to emit light.

In one embodiment, the driving method further includes:
within the first time period, controlling the light-emitting element in a (1+3k)^{th} row to emit light; within the second time period, controlling the light-emitting element in a (2+3k)^{th} row to emit light; and within the third time period, controlling the light-emitting element in a (3+3k)^{th} row to emit light.

In one embodiment, the driving method further includes:
within the first time period, controlling the light-emitting elements in a light-emitting unit in a (1+3j)^{th} row to emit light; within the second time period, controlling the light-emitting elements in a light-emitting unit in a (2+3j)^{th} row to emit light; and within the third time period, controlling the light-emitting elements in a light-emitting unit in a (3+3j)^{th} row to emit light, where j is an integer greater than or equal to 0.

In one embodiment, the driving method further includes:
within the first time period, controlling the light-emitting elements in a light-emitting unit in a (1+3j)^{th} row and a (1+3i)^{th} column, the light-emitting elements in a light-emitting unit in a (2+3j)^{th} row and a (2+3i)^{th} column, and the light-emitting elements in a light-emitting unit that is in a (3+3j)^{th} row and a (3+3i)^{th} column to emit light; within the second time period, controlling the light-emitting elements in a light-emitting unit in the (1+3j)^{th} row and the (2+3i)^{th} column, the light-emitting elements in a light-emitting unit in the (2+3j)^{th} row and the (3+3i)^{th} column, and the light-emitting elements in a light-emitting unit in the (3+3j)^{th} row and the (1+3i)^{th} column to emit light; and within the third time period, controlling the light-emitting elements in a light-emitting unit in the (1+3j)^{th} row and the (3+3i)^{th} column, the light-emitting elements in a light-emitting unit in the (2+3j)^{th} row and the (1+3i)^{th} column, and the light-emitting elements in a light-emitting unit in the (3+3j)^{th} row and the (2+3i)^{th} column to emit light, where i is an integer greater than or equal to 0, and j is an integer greater than or equal to 0.

### BRIEF DESCRIPTION OF THE DRAWINGS

In order to describe the embodiments of the present application more clearly, the accompanying drawings required for the embodiments of the present application are briefly described below.

FIG. 1 is a schematic diagram of a structure of a display panel according to an embodiment of the present application;

FIG. 2 is another schematic diagram of a structure of a display panel according to an embodiment of the present application;

FIG. 3 is a schematic diagram of a first pixel arrangement mode according to an embodiment of the present application;

FIG. 4-A is a schematic diagram of single-row light emission of light-emitting elements in different time periods in the case of a first pixel arrangement mode and M=N=2 according to an embodiment of the present application;

FIG. 4-B is another schematic diagram of staggered light emission of light-emitting elements in different time periods in the case of a first pixel arrangement mode and M=N=2 according to an embodiment of the present application;

FIG. 5-A is a schematic diagram of single-row light emission of light-emitting elements in different time periods in the case of a first pixel arrangement mode and M=N=3 according to an embodiment of the present application;

FIG. 5-B is another schematic diagram of staggered light emission of light-emitting elements in different time periods in the case of a first pixel arrangement mode and M=N=3 according to an embodiment of the present application;

FIG. 6 is a schematic diagram of a second pixel arrangement mode according to an embodiment of the present application;

FIG. 7 is a schematic diagram of single-row light emission of light-emitting units in different time periods in the case of a second pixel arrangement mode and M=N=3 according to an embodiment of the present application;

FIG. 8 is another schematic diagram of staggered light emission of light-emitting units in different time periods in the case of a second pixel arrangement mode and M=N=3 according to an embodiment of the present application;

FIG. 9 is a schematic flowchart of a driving method for a display panel according to an embodiment of the present application;

FIG. 10 is another schematic flowchart of a driving method for a display panel according to an embodiment of the present application;

FIG. 11 is still another schematic flowchart of a driving method for a display panel according to an embodiment of the present application;

FIG. 12 is yet another schematic flowchart of a driving method for a display panel according to an embodiment of the present application;

FIG. 13 is still yet another schematic flowchart of a driving method for a display panel according to an embodiment of the present application;

FIG. 14 is a further schematic flowchart of a driving method for a display panel according to an embodiment of the present application; and

FIG. 15 is a schematic diagram of a structure of a display apparatus according to an embodiment of the present application.

### DETAILED DESCRIPTION OF EMBODIMENTS

Features and exemplary embodiments of various embodiments of the present application will be described in detail below. In order to make the embodiments of the present application clearer, the present application is further described in detail below with reference to the accompanying drawings and embodiments. It should be understood that the specific embodiments described herein are merely configured to explain the present application and are not configured to limit the present application. The present application may be implemented without some of these specific details. The following description of the embodiments is merely to provide a better understanding of the present application by illustrating examples of the present application.

It should be noted that, herein, relative terms such as “first” and “second” are only used to distinguish one entity or operation from another entity or operation, and do not necessarily require or imply that such an actual relationship or order exists between these entities or operations. Moreover, the terms “include”, “comprise”, or any other variants thereof are intended to cover a non-exclusive inclusion, and a process, a method, an article, or a device that includes a list of elements not only includes those elements but also includes other elements that are not listed, or further includes elements inherent to such a process, method, article, or device. If no more limitations are made, an element limited by “comprising . . . ” does not exclude other identical elements existing in the process, the method, the article, or the device which includes the element.

It should be understood that the term “and/or” herein is merely the description of an association between associated objects, and indicates that three relationships may exist. For example, A and/or B may indicate that only A exists, both A and B exist, and only B exists. In addition, the character “/” herein generally indicates that an “or” relationship between associated objects.

Various modifications and variations can be made in the present application without departing from the spirit or scope of the present application. Therefore, the present application aims to cover the modifications and variations that fall within the scope of the corresponding claims (the claimed solutions) and equivalents thereof. It should be noted that implementations provided in the embodiments of the present application may be combined with each other without contradiction.

Before elaborating on the solutions provided in the embodiments of the present application, to facilitate understanding of the embodiments of the present application, the problems existing in the related art are specifically listed in the present application:

Pixels per inch (PPI) refers to the number of pixels per inch on a screen, which may also be referred to as the resolution of the screen. The resolution PPI is a very important parameter. When the resolution is higher, more detailed and clearer picture quality can be provided for a user, providing a better visual experience.

In order to improve the resolution of the screen, in some related technologies, the ratio of the number of drive circuits to the number of light-emitting elements is changed from the original 1:1 to 1:3, i.e., three light-emitting elements share one pixel circuit, which reduces the number of traces and the number of drive circuits, resulting in reduces an occupied area of a single light-emitting unit, and improves the resolution PPI of a display panel.

However, in the related technologies, the three light-emitting elements sharing one pixel circuit are often in the same row. For example, when a pixel arrangement mode of the light-emitting elements is “light-emitting elements in the same column emitting light of the same color”, R, G, and B light-emitting elements in the same row and three adjacent columns share one pixel circuit, only a limited way of light-emitting elements in the same row sharing the pixel circuit is provided, resulting in a limited way of light emission, which is applicable to only a specific pixel arrangement mode, resulting in a small range of use scenarios and poor flexibility.

In view of this, the embodiments of the present application provide a display panel and a driving method therefor, and a display apparatus, which can solve the problems of a limited way of light emission, poor flexibility, and a small range of use scenarios in the prior art.

The embodiments of the present application are described in detail below with reference to the accompanying drawings.

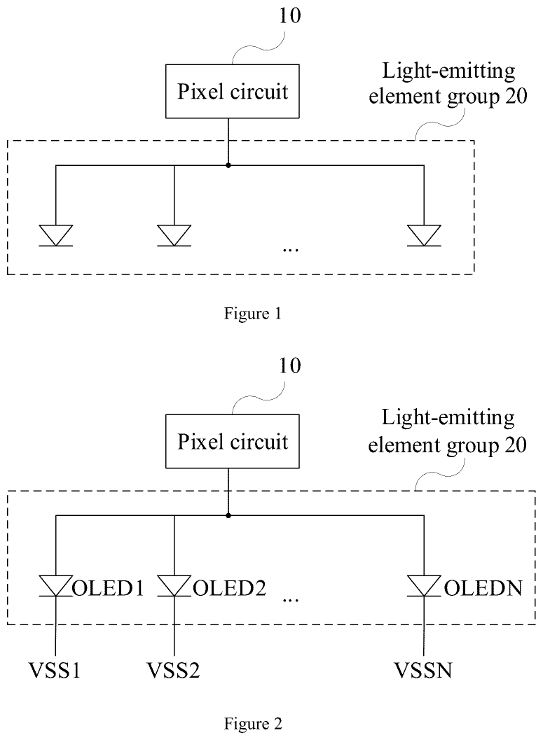

FIG. 1 is a schematic diagram of a display panel according to an embodiment of the present application. As shown in FIG. 1, the display panel includes:
a pixel circuit 10 and light-emitting element groups 20, where one light-emitting element group 20 includes N light-emitting elements, and all first electrodes of the N light-emitting elements are electrically connected to an output terminal of the same pixel circuit 10; and
the N light-emitting elements are located in different rows and emit light in different time periods within one frame, where N is an integer greater than 1.

Specifically, as shown in FIG. 1, the display panel includes the pixel circuit 10 and the light-emitting element groups 20, where one light-emitting element group 20 includes the N light-emitting elements located in different rows, and all the first electrodes of the N light-emitting elements are electrically connected to the output terminal of the same pixel circuit 10. Since the N light-emitting elements share one pixel circuit 10, the N light-emitting elements can emit light in different time periods within one frame.

In the display panel provided in this embodiment of the present application, the N light-emitting elements that share one pixel circuit being located in different rows are applicable to a pixel arrangement mode in which the light-emitting elements in the same column emit light of the same color, and are also applicable to other pixel arrangement modes, such as a Delta pixel arrangement mode, thereby expanding the range of applicable scenarios. Moreover, in the prior art, only three light-emitting elements in the same row can share one pixel circuit, and therefore three subframes are needed to display a complete picture. However, in this embodiment of the present application, the N light-emitting elements share one pixel circuit, where N may be 3 or other values, and for example, when N is 2, only two subframes are needed to display a complete picture, resulting in a more flexible and diversified way of light emission.

In some embodiments, as shown in FIG. 2,
second electrodes of the N light-emitting elements in the same light-emitting element group are connected to different power lines.

Specifically, as shown in FIG. 2, the second electrodes of the N light-emitting elements in the same light-emitting element group may be respectively connected to different power lines VSS1, VSS2, . . . , and VSSN. When the power line is configured to transmit a high-level signal, the light-emitting element OLED may be controlled to be turned off, and when the power line is configured to transmit a low-level signal, the light-emitting element OLED may be controlled to be turned on. For example, within a first time period t1, only the power line VSS1 in the N power lines is configured to transmit a low-level signal, and only OLED1 in the N light-emitting elements emits light. Within a second time period t2, only the power line VSS2 in the N power lines is configured to transmit a low-level signal, and only OLED2 in the N light-emitting elements emits light. One time period may be understood as one subframe. That is, since the N light-emitting elements share one pixel circuit, one pixel circuit can light only one of the N light-emitting elements at the same time. In this embodiment of the present application, by controlling the transmission of the high-level signal or low-level signal on the power line, it is possible to control a light-emitting element OLED to be lit and a time period within which the light-emitting element OLED is lit.

In an example, by connecting the N light-emitting elements sharing one pixel circuit to different control signal lines, it is also possible to control a light-emitting element OLED to be lit and a time period within which the light-emitting element OLED is lit. For example, the second electrodes of the N light-emitting elements in the same light-emitting element group are connected to different switch transistors, and a gate control signal EM may control a time period within which a switch transistor is turned on, to control a time period within which the light-emitting element is lit. For example, a control signal EM1 may control a time period within which the light-emitting element OLED1 is lit, a control signal EM2 may control a time period within which the light-emitting element OLED2 is lit, and so on. By providing different power lines VSS or control signal lines EM on N light-emitting paths of the N light-emitting elements sharing one pixel circuit, it is possible to control each light-emitting element OLED to be lit within different time periods.

In some embodiments, a working process of the display panel within one frame may include M subframes, only one of the N light-emitting elements emits light in one subframe, and the N light-emitting elements sequentially emit light respectively in the M subframes, where M=N.

Specifically, since the N light-emitting elements share one pixel circuit, only one of the N light-emitting elements can be in a light emitting state within one subframe, while the other light-emitting elements are in an off state, and the N light-emitting elements can emit light sequentially within the M subframes. Since the display panel includes the M subframes within one frame, when M=N, a complete picture can be displayed within one frame, i.e., all the light-emitting elements can be lit within one frame.

In some embodiments, one light-emitting element group includes two light-emitting elements, where the two light-emitting elements are located in two adjacent rows and the same column, or the two light-emitting elements are located in two adjacent rows and two adjacent columns; and

In one embodiment, one subframe is used as one time period, and the M subframes include a first time period, a second time period, . . . , and an M^{th} time period; and in the case of M=2,
the two light-emitting elements located in two adjacent rows and the same column emit light of the same color, where
within the first time period, the light-emitting element located in an odd-numbered row emits light; and within the second time period, the light-emitting element located in an even-numbered row emits light; or
within the first time period, the light-emitting element located in both an odd-numbered row and an odd-numbered column emits light, and the light-emitting element located in both an even-numbered row and an even-numbered column emits light; and within the second time period, the light-emitting element located in both an odd-numbered row and an even-numbered column emits light, and the light-emitting element located in both an even-numbered row and an odd-numbered column emits light; or

In one embodiment, one subframe is used as one time period, and the M subframes include a first time period, a second time period, . . . , and an M^{th} time period; and in the case of M=2,
the two light-emitting elements located in two adjacent rows and two adjacent columns emit light of different colors, where within the first time period, the light-emitting element located in an odd-numbered row emits light; and within the second time period, the light-emitting element located in an even-numbered row emits light.

One subframe may be understood as one time period, and the working process of the display panel within one frame may include the M subframes/time periods.

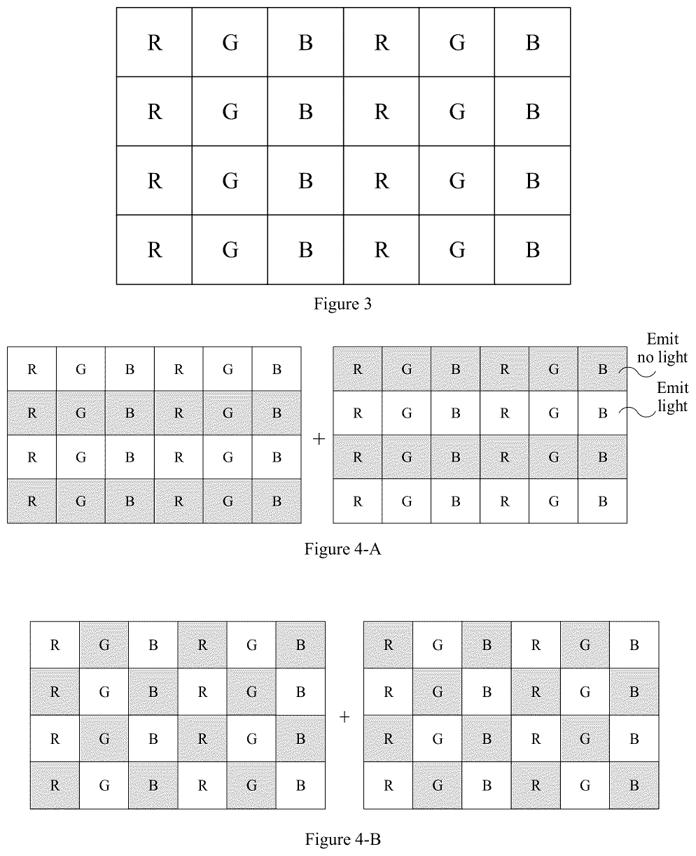

A pixel arrangement mode of “light-emitting elements in each column emitting light of the same color”, as shown in FIG. 3, may be referred to as a first pixel arrangement mode.

Specifically, as shown in FIG. 3, when a pixel arrangement mode in the display panel is the first pixel arrangement mode, one light-emitting element group may include two light-emitting elements, i.e., two light-emitting elements may share one pixel circuit. The two light-emitting elements sharing one pixel circuit may be located in two adjacent rows and the same column. For example, the light-emitting element in the first column and the first row and the light-emitting element in the first column and the second row may share one pixel circuit. Alternatively, the two light-emitting elements may be located in two adjacent rows and two adjacent columns. For example, the light-emitting element in the first row and the first column and the light-emitting element in the second row and the second column may share one pixel circuit. In other words, the two light-emitting elements sharing one pixel circuit may be two light-emitting elements that are vertically adjacent to each other in two rows and that emit light of the same color. For example, two adjacent R-OLEDs in the first column may share one pixel circuit, two adjacent G-OLEDs in the second column may share one pixel circuit, two adjacent B-OLEDs in the third column may share one pixel circuit, and so on. Alternatively, the two light-emitting elements sharing one pixel circuit may be light-emitting elements that are diagonally adjacent to each other in two rows and that emit light of different colors. For example, the R-OLED in the first row and the first column and the G-OLED in the second row and the second column may share one pixel circuit. The selection of positions of the N light-emitting elements sharing one pixel circuit is more flexible and diversified. The N light-emitting elements that are vertically adjacent to each other in two rows and that emit light of the same color may be selected to share one pixel circuit, or the N light-emitting elements that are diagonally adjacent to each other in two rows and that emit light of different colors may be selected to share one pixel circuit, resulting in higher flexibility.

In an embodiment, a first lighting mode in the case of “M=2, i.e., one frame includes two subframes” and “the two light-emitting elements sharing one pixel circuit emit light of the same color and are located in two adjacent rows and the same column” may be as follows: By configuring the power lines VSS1 and VSS2 to transmit the low-level signal within different time periods, it is possible to control the two light-emitting elements OLEDs sharing one pixel circuit to emit light in different time periods, where within the first time period t1, it is possible to make the light-emitting element located in odd-numbered rows emit light and the light-emitting elements located in even-numbered rows emit no light; and within the second time period t2, it is possible to make the light-emitting elements located in even-numbered rows emit light and the light-emitting element OLED located in odd-numbered rows emit no light. That is, ½ of the rows are lit within one time period, and all the light-emitting elements OLEDs in each lit row are lit. Such a lighting mode may be referred to as a single-row lighting mode.

For example, as shown in FIG. 4-A, within the first time period t1, the light-emitting elements located in the odd-numbered rows, namely, the first row, the third row, the fifth row, . . . , emit light, the light-emitting elements located in the even-numbered rows, namely, the second row, the fourth row, the sixth row, . . . , emit no light; and within the second time period t2, the light-emitting elements located in the even-numbered rows, namely, the second row, the fourth row, the sixth row, . . . , emit light, the light-emitting elements located in the odd-numbered rows, namely, the first row, the third row, the fifth row, . . . , emit no light. In this way, a complete image can be formed within one frame.

It should be noted that the first lighting mode in the case of “M=2, i.e., one frame includes two subframes” and “the two light-emitting elements sharing one pixel circuit emit light of the same color and are located in two adjacent rows and the same column”, as shown in FIG. 4-A, is a single-row lighting mode in which ½ of the rows are lit within one time period, and all the light-emitting elements OLEDs in each lit row are lit. This improves the resolution, but flickering occurs, affecting user experience. Therefore, the inventors have found through research that, by lighting all the rows and lighting only ½ of the light-emitting elements in each lit row within one time period, it is possible to improve the resolution while alleviating the flickering. Therefore, a staggered lighting mode is proposed.

In another embodiment, a second lighting mode in the case of “M=2, i.e., one frame includes two subframes” and “the two light-emitting elements sharing one pixel circuit emit light of the same color and are located in two adjacent rows and the same column” may be as follows: Within the first time period t1, the light-emitting element located in both an odd-numbered row and an odd-numbered column emits light, and the light-emitting element located in both an even-numbered row and an even-numbered column emits light; and within the second time period t2, the light-emitting element located in both an odd-numbered row and an even-numbered column emits light, and the light-emitting element located in both an even-numbered row and an odd-numbered column emits light, which is the staggered lighting mode.

For example, as shown in FIG. 4-B, within the first time period t1, the light-emitting element located in both an odd-numbered row and an odd-numbered column and the light-emitting element located in both an even-numbered row and an even-numbered column emit light, and the light-emitting element located in both an odd-numbered row and an even-numbered column and the light-emitting element located in both an even-numbered row and an odd-numbered column emit no light; and within the second time period t2, a light emitting status is opposite to that within the first time period, i.e., the light-emitting element located in both an odd-numbered row and an even-numbered column and the light-emitting element located in an even-numbered row and an odd-numbered column emit light, and the light-emitting element located in an odd-numbered row and an odd-numbered column and the light-emitting element located in an even-numbered row and an even-numbered column emit no light. The lighting mode shown in FIG. 4-B is a staggered lighting mode, which can solve the flickering problem in the single-row lighting mode shown in FIG. 4-A.

It should be noted that in this embodiment of the present application, when the two light-emitting elements sharing one pixel circuit are located in two adjacent rows and the same column, in addition to the single-row lighting mode, the staggered lighting mode or other lighting modes can also be implemented, which are not enumerated herein. It follows the common rules “within one subframe, one of the two light-emitting elements sharing one pixel circuit is on and the other is off” and “pictures in two subframes are complementary to form a complete picture”.

In still another embodiment, a lighting mode in the case of “M=2, i.e., one frame includes two subframes” and “the two light-emitting elements located in two adjacent rows and two adjacent columns emit light of different colors” may be as follows: Within the first time period, the light-emitting element located in an odd-numbered row emits light, and the light-emitting element located in an even-numbered row emits no light; and within the second time period, the light-emitting element located in an even-numbered row emits light, and the light-emitting element located in an odd-numbered row emits no light. For a lighting effect, reference may be made to FIG. 4-A. Therefore, in the case of M=N=2, the lighting mode shown in FIG. 4-A can be implemented by the two light-emitting elements in two adjacent rows and the same column sharing one pixel circuit or the two light-emitting elements in two adjacent rows and two adjacent columns sharing one pixel circuit, resulting in a more flexible and diversified way of light emission.

In some embodiments, one light-emitting element group includes three light-emitting elements, where the three light-emitting elements are located in three sequentially adjacent rows and the same column, or the three light-emitting elements are located in three sequentially adjacent rows and three sequentially adjacent columns.

In one embodiment, one subframe is used as one time period, and the M subframes include a first time period, a second time period, a third time period, . . . , and an M^{th} time period; and in the case of M=3,
the three light-emitting elements located in three sequentially adjacent rows and the same column emit light of the same color, where
within the first time period, the light-emitting element in a (1+3k)^{th} row emits light; within the second time period, the light-emitting element in a (2+3k)^{th} row emits light; and within the third time period, the light-emitting element in a (3+3k)^{th} row emits light, where k is an integer greater than or equal to 0; or

In one embodiment, one subframe is used as one time period, and the M subframes include a first time period, a second time period, a third time period, . . . , and an M^{th} time period; and in the case of M=3,
the three light-emitting elements located in three sequentially adjacent rows and three sequentially adjacent columns emit light of different colors, where within the first time period, the light-emitting element in a (1+3k)^{th} row emits light; within the second time period, the light-emitting element in a (2+3k)^{th} row emits light; and within the third time period, the light-emitting element in a (3+3k)^{th} row emits light, where k is an integer greater than or equal to 0.

Specifically, one light-emitting element group may include three light-emitting elements, i.e., three light-emitting elements may share one pixel circuit. In an example, the three light-emitting elements sharing one pixel circuit may be located in three sequentially adjacent rows and the same column. For example, as shown in FIG. 3, the light-emitting element in the first row and the first column, the light-emitting element in the second row and the first column, and the light-emitting element in the third row and the first column may share one pixel circuit, and so on. In another example, the three light-emitting elements sharing one pixel circuit are located in three sequentially adjacent rows and three sequentially adjacent columns. For example, as shown in FIG. 3, the light-emitting element in the first row and the first column, the light-emitting element in the second row and the second column, and the light-emitting element in the third row and the third column may share one pixel circuit, and so on.

In an embodiment, when a pixel arrangement mode is the first pixel arrangement mode, the three light-emitting elements sharing one pixel circuit may be light-emitting elements that emit light of the same color and that are located in three sequentially adjacent rows and the same column. For example, as shown in FIG. 3, the light-emitting element R-OLED in the first row and the first column, the light-emitting element R-OLED in the second row and the first column, and the light-emitting element R-OLED in the third row and the first column may share one pixel circuit, and so on. A first lighting mode in the case of “M=3, i.e., one frame includes three subframes” and “the three light-emitting elements sharing one pixel circuit are light-emitting elements that emit light of the same color and that are located in three sequentially adjacent rows and the same column” may be as follows: Within the first time period t1, the light-emitting element in the (1+3k)^{th} row emits light, and the light-emitting element in the other rows emit no light; within the second time period t2, the light-emitting element in the (2+3k)^{th} row emits light, and the light-emitting elements in the other rows emit no light; and within the third time period, the light-emitting element in the (3+3k)^{th} row emits light, and the light-emitting elements in the other rows emit no light.

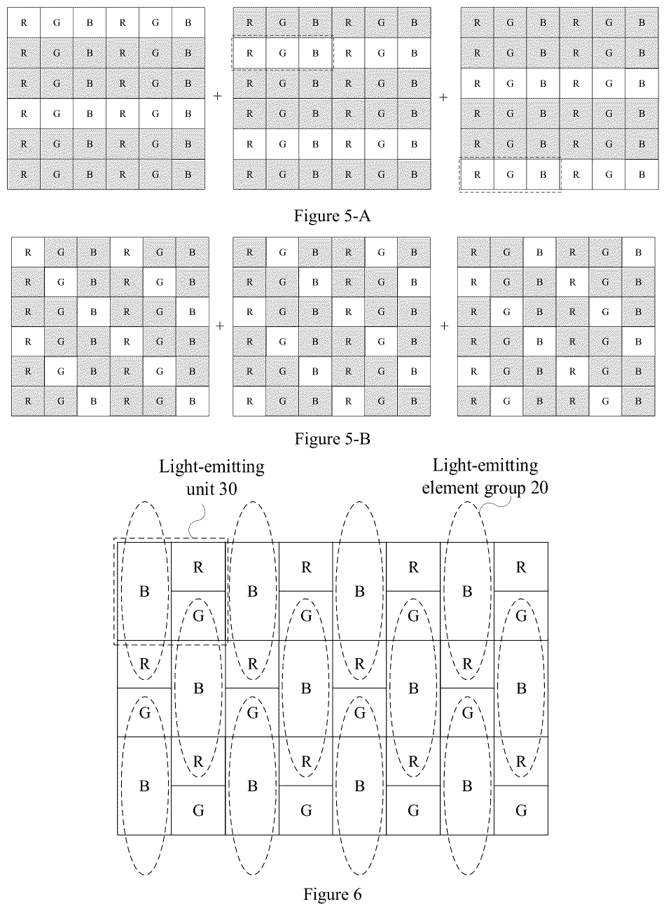

For example, as shown in FIG. 5-A, within the first time period, the light-emitting elements in the first row, the fourth row, the seventh row, . . . , emit light, and the light-emitting elements in the other rows emit no light. Similarly, within the second time period, the light-emitting elements in the second row, the fifth row, the eighth row, . . . , emit light, and the light-emitting elements in the other rows emit no light; and within the second time period, the light-emitting elements in the third row, the sixth row, the ninth row, . . . , emit light, and the light-emitting elements in the other rows emit no light.

It should be noted that the first lighting mode shown in FIG. 5-A is a single-row lighting mode, i.e., ⅓ of the rows are lit within one time period and all the OLEDs in each lit row are lit, resulting in flickering. Therefore, the inventors have found through research that, by lighting all the rows and lighting only ⅓ of the light-emitting elements in each lit row within one time period, it is possible to alleviate the flickering. Therefore, a second lighting mode in the case of the pixel arrangement mode in which the light-emitting elements in each column emit light of the same color and M=N=3 is proposed.

In another embodiment, the second lighting mode in the case of “M=3, i.e., one frame includes three subframes” and “the three light-emitting elements sharing one pixel circuit are light-emitting elements that emit light of the same color and that are located in three sequentially adjacent rows and the same column” may be as follows: A first-color light-emitting element, a second-color light-emitting element, and a third-color light-emitting element in each row emit light in different time periods within one frame.

Specifically, as shown in FIG. 5-B, the first-color light-emitting element, the second-color light-emitting element, and the third-color light-emitting element in each row emitting light in different time periods within one frame may include:
within the first time period t1, the first-color light-emitting elements in the first row, the fourth row, the seventh row, . . . , the second-color light-emitting elements in the second row, the fifth row, the eighth row, . . . , and the third-color light-emitting elements in the third row, the sixth row, the ninth row, . . . emit light, and the other light-emitting elements emit no light. For example, the R-OLEDs in the first row, the fourth row, the seventh row, . . . , the G-OLEDs in the second row, the fifth row, the eighth row, . . . , and the B-OLEDs in the third row, the sixth row, the ninth row, . . . emit light, and the other OLEDs emit no light.
within the second time period t2, the second-color light-emitting elements in the first row, the fourth row, the seventh row, . . . , the third-color light-emitting elements in the second row, the fifth row, the eighth row, . . . , and the first-color light-emitting elements in the third row, the sixth row, the ninth row, . . . emit light.
within the third time period t3, the third-color light-emitting elements in the first row, the fourth row, the seventh row, . . . , the first-color light-emitting elements in the second row, the fifth row, the eighth row, . . . , and the second-color light-emitting elements in the third row, the sixth row, the ninth row, . . . emit light. The second lighting mode in the case of the first pixel arrangement mode and M=N=3 that is provided in this embodiment of the present application is a staggered lighting mode. In this embodiment of the present application, it is possible to not only make three light-emitting elements share one pixel circuit to improve the resolution, but also solve the flickering problem in the case of the first pixel arrangement mode and M=N=3 while improving the resolution, thereby improving a display effect.

In still another embodiment, in the case of “M=3, i.e., one frame includes three subframes” and “the three light-emitting elements sharing one pixel circuit emit light of different colors and are located in three sequentially adjacent rows and three sequentially adjacent columns”, within the first time period t1, the light-emitting element in the (1+3k)^{th} row emits light; within the second time period t2, the light-emitting element in the (2+3k)^{th} row emits light; and within the third time period t3, the light-emitting element in the (3+3k)^{th} row emits light, where k is an integer greater than or equal to 0. For a lighting effect, reference may be made to FIG. 5-A. Therefore, in the case of M=N=3, the lighting mode shown in FIG. 5-A can be implemented by the three light-emitting elements in three sequentially adjacent rows and the same column sharing one pixel circuit or the three light-emitting elements in three sequentially adjacent rows and three sequentially adjacent columns sharing one pixel circuit, resulting in a more flexible and diversified way of light emission.

It should be noted that in this embodiment of the present application, FIG. 3 shows the first pixel arrangement mode. in the case of the first pixel arrangement mode and M=N=2, there are two lighting modes. The first lighting mode is a single-row lighting mode, and reference may be made to FIG. 4-A. The second lighting mode is a staggered lighting mode, and reference may be made to FIG. 4-B. Alternatively, other lighting modes can also be implemented, which are not enumerated herein. It follows the common rules “in one subframe, one of the two light-emitting elements sharing one pixel circuit is on and the other is off” and “pictures in two subframes are complementary to form a complete picture”. In the case of the first pixel arrangement mode and M=N=3, there are also two lighting modes. The first lighting mode is a single-row lighting mode, and reference may be made to FIG. 5-A. The second lighting mode is a staggered lighting mode, and reference may be made to FIG. 5-B. Alternatively, other lighting modes can also be implemented, which are not enumerated herein. It follows the common rules “in one subframe, one of the three light-emitting elements sharing one pixel circuit is on and the other two are off” and “pictures in three subframes are complementary to form a complete picture”.

In some embodiments, as shown in FIG. 6, one light-emitting element group includes three light-emitting elements, where the three light-emitting elements are located in three sequentially adjacent rows and the same column, and the three light-emitting elements emit light of different colors;

In one embodiment, the light-emitting element groups in odd-numbered columns are arranged in parallel, the light-emitting element groups in even-numbered columns are arranged in parallel, and the light-emitting element groups in odd-numbered columns and even-numbered columns are staggered; and

In one embodiment, three adjacent light-emitting elements that emit light of different colors constitute one light-emitting unit, one light-emitting unit includes a first-color light-emitting element, a second-color light-emitting element, and a third-color light-emitting element, in the same light-emitting unit, the first-color light-emitting element is located in a separate column and the second-color light-emitting element and the third-color light-emitting element are located in the same column, and the light-emitting units are arranged in an array.

Specifically, the light-emitting element group 20 in which one pixel circuit is shared may include three light-emitting elements that are located in three sequentially adjacent rows and the same column and that emit light of different colors. That is, the three light-emitting elements sharing one pixel circuit may be three light-emitting elements R, G, and B that are located in three sequentially adjacent rows and the same column.

In an example, the Delta pixel arrangement mode shown in FIG. 6 may be referred to as the second pixel arrangement mode. As shown in FIG. 6, the three light-emitting elements R, G, and B located in different rows and the same column may share one pixel circuit. That is, the light-emitting element group 20 may include the three light-emitting elements R, G, and B located in different rows and the same column. Moreover, the light-emitting element groups 20 in the odd-numbered columns are arranged in parallel, the light-emitting element groups 20 in the even-numbered columns are arranged in parallel, and the light-emitting element groups 20 in odd-numbered columns and even-numbered columns are staggered. Each light-emitting element group 20 includes three light-emitting elements of G, B, and R colors. In the Delta pixel arrangement mode shown in FIG. 6, three adjacent light-emitting elements that emit light of different colors may constitute one light-emitting unit 30, and the light-emitting units 30 are arranged in an array. One light-emitting unit 30 includes a first-color light-emitting element, a second-color light-emitting element, and a third-color light-emitting element. In the same light-emitting unit 30, the third-color light-emitting element is located in a separate column, and the first-color light-emitting element and the second-color light-emitting element are located in the same column. The light-emitting elements of three colors in the same light-emitting unit 30 are respectively located in three light-emitting element groups 20.

For example, as shown in FIG. 6, in the same light-emitting unit 30, the third-color light-emitting element B-OLED is located in a separate column, and the first-color light-emitting element R-OLED and the second-color light-emitting element G-OLED are located in the same column. A plurality of light-emitting units 30 are arranged in an array in the display panel.

It should be noted that, as shown in FIG. 6, when the light-emitting element group 20 in which one pixel circuit is shared includes “three light-emitting elements” that are located in three sequentially adjacent rows and the same column and that emit light of different colors, i.e., when “three light-emitting elements” that are located in three sequentially adjacent rows and the same column and that emit light of different colors share one pixel circuit, there may be one or two separate light-emitting elements at an edge of the display panel that cannot form a complete light-emitting element group. Therefore, less than three light-emitting elements at the edge may serve as an element group and share one pixel circuit, and a time period within which each light-emitting element is lit is based on whether the light-emitting elements in the light-emitting unit are lit or off simultaneously.

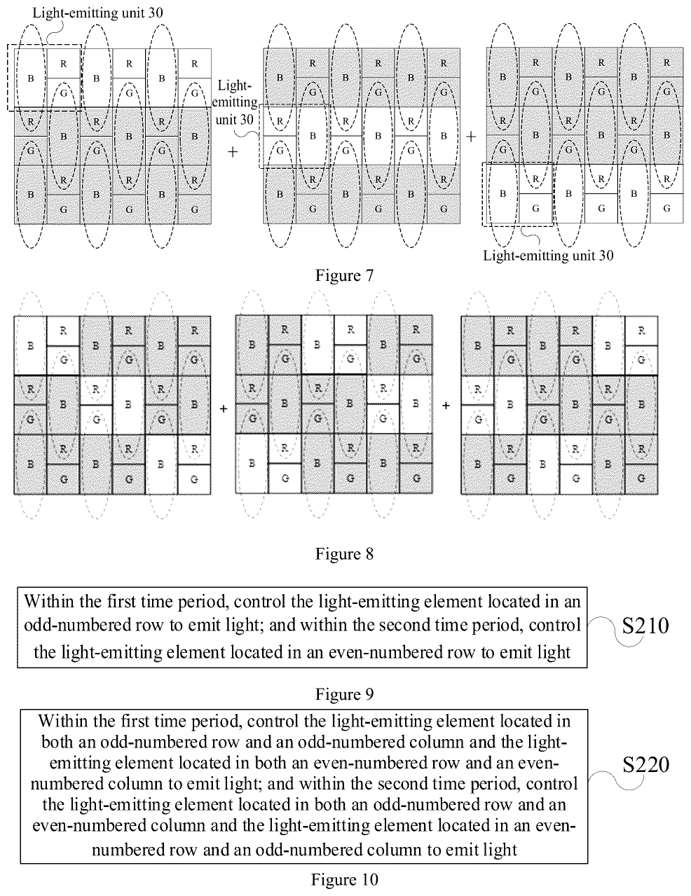

In some embodiments, as shown in FIG. 7, one subframe is used as one time period, and the M subframes include a first time period, a second time period, a third time period, . . . , and an M^{th} time period; and in the case of M=3,
within the first time period, the light-emitting elements in the light-emitting unit in a (1+3j)^{th} row emit light; within the second time period, the light-emitting elements in the light-emitting unit in a (2+3j)^{th} row emit light; and within the third time period, the light-emitting elements in the light-emitting unit in a (3+3j)^{th} row emit light, where j is an integer greater than or equal to 0; and

In one embodiment, second electrodes of the light-emitting elements in the light-emitting units 30 in the same row are connected to the same power line.

Specifically, the first lighting mode in the case of the second pixel arrangement mode and M=N=3 may be as follows: Within the first time period t1, the light-emitting elements in the light-emitting units in the first row, the fourth row, the seventh row, . . . emit light, and the light-emitting elements in the light-emitting units in the other rows emit no light; within the second time period t2, the light-emitting elements in the light-emitting units in the second row, the fifth row, the eighth row, . . . emit light, and the light-emitting elements in the light-emitting units in the other rows emit no light; and within the third time period t3, the light-emitting elements in the light-emitting units in the third row, the sixth row, the ninth row, . . . emit light, and the light-emitting elements in the light-emitting units in the other rows emit no light.

In an example, as shown in FIG. 7, the light-emitting elements G, B, and R in three sequentially adjacent rows and the same column may share one pixel circuit, and the three adjacent light-emitting elements that emit light of different colors constitute one light-emitting unit 30. The plurality of light-emitting units 30 are arranged in an array. In the same light-emitting unit 30, the third-color light-emitting element B-OLED is located in a separate column, and the first-color light-emitting element R-OLED and the second-color light-emitting element G-OLED are located in the same column. Using the light-emitting unit as a minimum unit of light emission, all the light-emitting elements in the light-emitting unit are lit or off within the same time period. For example, within the first time period t1, the first row, the fourth row, the seventh row, . . . of the light-emitting units are lit, i.e., all the light-emitting elements in the light-emitting units in the first row, the fourth row, the seventh row, . . . emit light, and all the light-emitting elements in the light-emitting units in the other rows emit no light. Similarly, within the second time period t2, the second row, the fifth row, the eighth row, . . . in which the light-emitting units are located are lit, and within the third time period t3, the third row, the sixth row, the ninth row, . . . in which the light-emitting units are located are lit. Within each time period, only ⅓ of the rows are lit, and all the light-emitting elements in each light-emitting units in each lit row are lit, making it possible to display a complete image after superimposition within one frame.

It should be noted that, the inventors have found through research that the first lighting mode in the case of the second pixel arrangement mode and M=N=3, as shown in FIG. 7, is a single-row lighting mode. As shown in FIG. 7, the light-emitting unit 30 is used as the minimum unit of light emission, i.e., the three light-emitting elements in the light-emitting unit 30 need to simultaneously emit light or simultaneously emit no light, Therefore, the three light-emitting elements in the light-emitting unit 30 all come from different light-emitting element groups 20, and the light-emitting elements OLEDs in the same light-emitting unit 30 may be connected to the same power line VSS. Further, as shown in FIG. 7, in the single-row lighting mode in the case of the second pixel arrangement mode, all the light-emitting units in each row may be lit or off, and the light-emitting elements in the light-emitting units in the same row may be connected to the same power line. For example, the light-emitting elements in the light-emitting units in the first row, the fourth row, the seventh row, . . . may be connected to the power line VSS1; the light-emitting elements in the light-emitting units in the second row, the fifth row, the eighth row, . . . may be connected to the power line VSS2; and the light-emitting elements in the light-emitting units in the third row, the sixth row, the ninth row, . . . may be connected to the power line VSS3. It is possible to further save wiring and improve the resolution in the case of the second pixel arrangement mode and M=N=3.

It should also be noted that the first lighting mode in the case of the second pixel arrangement mode and M=N=3 is a single-row lighting mode in units of the light-emitting unit. That is, within one time period, ⅓ of the rows in which the light-emitting units are located are lit, and all the “light-emitting units” in each lit row are lit, resulting in flickering. The inventors have found through research that, by lighting all the rows and lighting only ⅓ of the “light-emitting units” in each lit row within one time period, it is possible to alleviate the flickering. Therefore, a second lighting mode in the case of the second pixel arrangement mode and M=N=3 is proposed.

In some embodiments, as shown in FIG. 8, one subframe is used as one time period, and the M subframes include a first time period, a second time period, a third time period, . . . , and an M^{th} time period; and in the case of N=3,
within the first time period, the light-emitting elements in the light-emitting unit in a (1+3j)^{th} row and a (1+3i)^{th} column, the light-emitting elements in the light-emitting unit in a (2+3j)^{th} row and a (2+3i)^{th} column, and the light-emitting elements in the light-emitting unit in a (3+3j)^{th} row and a (3+3i)^{th} column emit light; within the second time period, the light-emitting elements in the light-emitting unit in the (1+3j)^{th} row and the (2+3i)^{th} column, the light-emitting elements in the light-emitting unit in the (2+3j)^{th} row and the (3+3i)^{th} column, and the light-emitting elements in the light-emitting unit in the (3+3j)^{th} row and the (1+3i)^{th} column emit light; and within the third time period, the light-emitting elements in the light-emitting unit in the (1+3j) th row and the (3+3i) th column, the light-emitting elements in the light-emitting unit in the (2+3j) th row and the (1+3i) th column, and the light-emitting elements in the light-emitting unit in the (3+3j) th row and the (2+3i) th column emit light, where i is an integer greater than or equal to 0, and j is an integer greater than or equal to 0.

Specifically, as shown in FIG. 8, the second lighting mode in the case of the second pixel arrangement mode and M=N=3 may be as follows: Within the first time period t1, the light-emitting unit in the (1+3j)^{th} row and the (1+3i)^{th} column, the light-emitting unit in the (2+3j)^{th} row and the (2+3i)^{th} column, and the light-emitting unit in the (3+3j)^{th} row and the (3+3i)^{th} column are lit; within the second time period, the light-emitting unit in the (1+3j)^{th} row and the (2+3i)^{th} column, the light-emitting unit in the (2+3j)^{th} row and the (3+3i)^{th} column, and the light-emitting unit in the (3+3j)^{th} row and the (1+3i)^{th} column are lit; and within the third time period, the light-emitting unit in the (1+3j)^{th} row and the (3+3i)^{th} column, the light-emitting unit in the (2+3j)^{th} row and the (1+3i)^{th} column, and the light-emitting unit in the (3+3j)^{th} row and the (2+3i)^{th} column are lit. For example, as shown in FIG. 8, by lighting all the rows and lighting only ⅓ of the light-emitting units in each lit row within one time period, it is possible to alleviate the flickering caused by single-row lighting.

It should be noted that in this embodiment of the present application, FIG. 6 shows the second pixel arrangement mode. In the case of the second pixel arrangement mode and M=N=3, there are two lighting modes in which the light-emitting unit is used as the minimum unit of light emission. The first lighting mode is a single-row lighting mode, and reference may be made to FIG. 7. The second lighting mode is a staggered lighting mode, and reference may be made to FIG. 8.

Based on the embodiment of the present application further provides a driving method for a display panel. The driving method may be used to drive the display panel described in any one of the above embodiments.

In the driving method for a display panel provided in this embodiment of the present application, the display panel may include a pixel circuit and light-emitting element groups, where one light-emitting element group includes N light-emitting elements, and all first electrodes of the N light-emitting elements are electrically connected to an output terminal of the same pixel circuit; and
the N light-emitting elements are located in different rows and emit light in different time periods within one frame, where N is an integer greater than 1; and
the driving method includes:
controlling the N light-emitting elements located in different rows to emit light in different time periods within one frame.

Specifically, since the N light-emitting elements in different rows share one pixel circuit, the N light-emitting elements can emit light sequentially in different time periods.

In a first pixel arrangement mode, when N=2, two light-emitting elements share one pixel circuit. For example, two light-emitting elements in two adjacent rows and the same column may share one pixel circuit, and the two light-emitting elements sharing one pixel circuit may be controlled to emit light in different time periods within one frame, to achieve the lighting effect shown in FIG. 4-A or FIG. 4-B. For another example, alternatively, two light-emitting elements in two adjacent rows and two adjacent columns may share one pixel circuit, and the two light-emitting elements sharing one pixel circuit may be controlled to emit light in different time periods within one frame, making it possible to achieve the lighting effect shown in FIG. 4-A. When N=3, three light-emitting elements share one pixel circuit. For example, three light-emitting elements in sequentially adjacent rows and the same column may share one pixel circuit, and the three light-emitting elements sharing one pixel circuit may be controlled to emit light in different time periods within one frame, to achieve the lighting effect shown in FIG. 5-A or FIG. 5-B. For another example, alternatively, three light-emitting elements in three sequentially adjacent rows and three sequentially adjacent columns may share one pixel circuit, and the three light-emitting elements sharing one pixel circuit may be controlled to emit light in different time periods within one frame, making it possible to achieve the lighting effect shown in FIG. 5-A, resulting in a more flexible and diversified way of light emission.

In a second pixel arrangement mode, when N=3, three light-emitting elements share one pixel circuit. Three light-emitting elements that are located in three sequentially adjacent rows and the same column and that emit light of different colors may share one pixel circuit, and the three light-emitting elements sharing one pixel circuit may be controlled to emit light in different time periods within one frame, to achieve the lighting effect shown in FIG. 7 or FIG. 8. It is applicable to different pixel arrangement modes, resulting in a wide range of applications and a more flexible and diversified way of light emission.

In an embodiment, as shown in FIG. 9, the driving method includes step S210:

S210: Within the first time period, control the light-emitting element located in an odd-numbered row to emit light; and within the second time period, control the light-emitting element located in an even-numbered row to emit light.

Specifically, step S210 may be understood as follows: In the case of the first pixel arrangement mode of the light-emitting elements and M=N=2, the N light-emitting elements may be controlled to emit light in different time periods within one frame. Therefore, within the first time period t1, the light-emitting element located in an odd-numbered row emits light, and the light-emitting element located in an even-numbered row emits no light; and within the second time period t2, the light-emitting element located in an even-numbered row emits light, and the light-emitting element located in an odd-numbered row emits no light. The resolution can be improved by making the two light-emitting elements share one pixel circuit. For a lighting effect, reference may be made to FIG. 4-A.

In some embodiments, as shown in FIG. 10, the driving method further includes step S220:

S220: Within the first time period, control the light-emitting elements located in odd-numbered rows and odd-numbered columns and the light-emitting elements located in even-numbered rows and even-numbered columns to emit light; and within the second time period, control the light-emitting element located in both an odd-numbered row and an even-numbered column and the light-emitting element located in both an even-numbered row and an odd-numbered column to emit light.

Specifically, step S220 may be understood as follows: In the case of the first pixel arrangement mode of the light-emitting elements and M=N=2, within the first time period t1, the light-emitting elements located in the odd-numbered rows and the odd-numbered columns and the light-emitting elements located in the even-numbered rows and the even-numbered columns may be controlled to emit light, and the other light-emitting elements emit no light; and within the second time period t2, the light-emitting elements located in the odd-numbered rows and the even-numbered columns and the light-emitting elements located in the even-numbered rows and the odd-numbered columns may be controlled to emit light, and the other light-emitting elements emit no light. Reference may be made to FIG. 4-B. By means of the staggered lighting mode shown in FIG. 4-B, the flickering problem caused by single-row lighting in the case of the first pixel arrangement mode of the light-emitting elements shown in FIG. 4-A and M=N=2 may be solved.

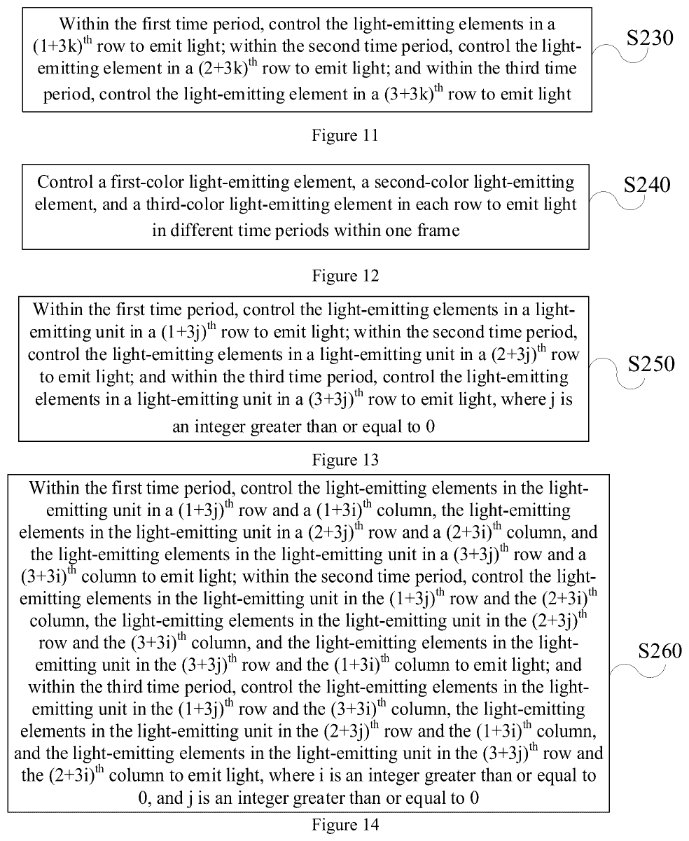

In some embodiments, as shown in FIG. 11, the driving method further includes step S230:

S230: Within the first time period, control the light-emitting element in a (1+3k)^{th} row to emit light; within the second time period, control the light-emitting element in a (2+3k)^{th} row to emit light; and within the third time period, control the light-emitting element in a (3+3k)^{th} row to emit light.

Specifically, step S230 may be understood as follows: In the case of the first pixel arrangement mode of the light-emitting elements and M=N=3, within the first time period t1, the light-emitting element in the (1+3k)^{th} row may be controlled to emit light, and the other light-emitting elements emit no light; within the second time period t2, the light-emitting element in the (2+3k)^{th} row may be controlled to emit light, and the other light-emitting elements emit no light; and within the third time period, the light-emitting element in the (3+3k)^{th} row may be controlled to emit light, and the other light-emitting elements emit no light. The resolution can be further improved by making the three light-emitting elements share one pixel circuit. For a lighting effect, reference may be made to FIG. 5-A.

In some embodiments, as shown in FIG. 12, the driving method further includes step S240:

S240: Control a first-color light-emitting element, a second-color light-emitting element, and a third-color light-emitting element in each row to emit light in different time periods within one frame.

In one embodiment, within the first time period, the first-color light-emitting element in a (1+3k)^{th} row, the second-color light-emitting element in a (2+3k)^{th} row, and the third-color light-emitting element in a (3+3k)^{th} row are controlled to emit light; within the second time period, the second-color light-emitting element in the (1+3k)^{th} row, the third-color light-emitting element in the (2+3k)^{th} row, and the first-color light-emitting element in the (3+3k)^{th} row are controlled to emit light; and within the third time period, the third-color light-emitting element in the (1+3k)^{th} row, the first-color light-emitting element in the (2+3k)^{th} row, and the second-color light-emitting element in the (3+3k)^{th} row are controlled to emit light.

Specifically, step S240 may be understood as follows: In the case of the first pixel arrangement mode of the light-emitting elements and M=N=3, the first-color light-emitting element, the second-color light-emitting element, and the third-color light-emitting element in each row may be controlled to emit light in different time periods within one frame. For example, within the first time period t1, the first-color light-emitting element in the (1+3k)^{th} row, the second-color light-emitting element in the (2+3k)^{th} row, and the third-color light-emitting element in the (3+3k)^{th} row are controlled to emit light, and the other light-emitting elements emit no light; within the second time period t2, the second-color light-emitting element in the (1+3k)^{th} row, the third-color light-emitting element in the (2+3k)^{th} row, and the first-color light-emitting element in the (3+3k)^{th} row are controlled to emit light, and the other light-emitting elements emit no light; and within the third time period t3, the third-color light-emitting element in the (1+3k)^{th} row, the first-color light-emitting element in the (2+3k)^{th} row, and the second-color light-emitting element in the (3+3k)^{th} row are controlled to emit light, and the other light-emitting elements emit no light. Reference may be made to FIG. 5-B. By means of the staggered lighting mode shown in FIG. 5-B, the flickering problem caused by single-row lighting in the case of the first pixel arrangement mode of the light-emitting elements shown in FIG. 5-A and M=N=3 may be solved.

In some embodiments, as shown in FIG. 13, the driving method further includes step S250:

S250: Within the first time period, control the light-emitting elements in a light-emitting unit in a (1+3j)^{th} row to emit light; within the second time period, control the light-emitting elements in a light-emitting unit in a (2+3j)^{th} row to emit light; and within the third time period, control the light-emitting elements in a light-emitting unit in a (3+3j)^{th} row to emit light, where j is an integer greater than or equal to 0.

Specifically, step S250 may be understood as follows: In the case of the second pixel arrangement mode of the light-emitting elements and M=N=3, within the first time period t1, the light-emitting elements in a light-emitting unit in the (1+3j)^{th} row may be controlled to emit light, and the light-emitting elements in the light-emitting units in the other rows emit no light; within the second time period t2, the light-emitting elements in the light-emitting unit in the (2+3j)^{th} row may be controlled to emit light, and the light-emitting elements in the light-emitting units in the other rows emit no light; and within the third time period, the light-emitting elements in the light-emitting unit in the (3+3j)^{th} row may be controlled to emit light, and the light-emitting elements in the light-emitting units in the other rows emit no light. The resolution can be further improved by making the three light-emitting elements share one pixel circuit. For a lighting effect, reference may be made to FIG. 7.

In some embodiments, as shown in FIG. 14, the driving method further includes step S260:

S260: Within the first time period, control the light-emitting elements in the light-emitting unit in a (1+3j)^{th} row and a (1+3i)^{th} column, the light-emitting elements in the light-emitting unit in a (2+3j)^{th} row and a (2+3i)^{th} column, and the light-emitting elements in the light-emitting unit in a (3+3j)^{th} row and a (3+3i)^{th} column to emit light; within the second time period, control the light-emitting elements in the light-emitting unit in the (1+3j)^{th} row and the (2+3i)^{th} column, the light-emitting elements in the light-emitting unit in the (2+3j)^{th} row and the (3+3i)^{th} column, and the light-emitting elements in the light-emitting unit in the (3+3j)^{th} row and the (1+3i)^{th} column to emit light; and within the third time period, control the light-emitting elements in the light-emitting unit in the (1+3j)^{th} row and the (3+3i)^{th} column, the light-emitting elements in the light-emitting unit in the (2+3j)^{th} row and the (1+3i)^{th} column, and the light-emitting elements in the light-emitting unit in the (3+3j)^{th} row and the (2+3i)^{th} column to emit light, where i is an integer greater than or equal to 0, and j is an integer greater than or equal to 0.

Specifically, step S260 may be understood as follows: In the case of the second pixel arrangement mode of the light-emitting elements and M=N=3, within the first time period t1, the light-emitting elements in the light-emitting unit in the (1+3j)^{th} row and the (1+3i)^{th} column, the light-emitting elements in the light-emitting unit in the (2+3j)^{th} row and the (2+3i)^{th} column, and the light-emitting elements in the light-emitting unit in the (3+3j)^{th} row and the (3+3i)^{th} column may be controlled to emit light, and the light-emitting elements in the other light-emitting units emit no light; within the second time period t2, the light-emitting elements in the light-emitting unit in the (1+3j)^{th} row and the (2+3i)^{th} column, the light-emitting elements in the light-emitting unit in the (2+3j)^{th} row and the (3+3i)^{th} column, and the light-emitting elements in the light-emitting unit in the (3+3j)^{th} row and the (1+3i)^{th} column may be controlled to emit light, and the light-emitting elements in the other light-emitting units emit no light; and within the third time period t3, the light-emitting elements in the light-emitting unit in the (1+3j)^{th} row and the (3+3i)^{th} column, the light-emitting elements in the light-emitting unit in the (2+3j)^{th} row and the (1+3i)^{th} column, and the light-emitting elements in the light-emitting unit in the (3+3j)^{th} row and the (2+3i)^{th} column may be controlled to emit light, and the light-emitting elements in the other light-emitting units emit no light. For a lighting effect, reference may be made to FIG. 8. By means of the staggered lighting mode in which the light-emitting unit is used as the minimum unit of light emission shown in FIG. 8, the flickering problem caused by single-row lighting in the case of the second pixel arrangement mode of the light-emitting elements shown in FIG. 7 and M=N=3 may be solved.

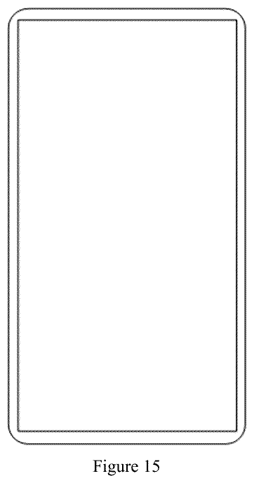

Referring to FIG. 15, FIG. 15 is a schematic diagram of a display apparatus according to the present application. The display apparatus may include a display panel. The display apparatus may be at least one of a wearable device, a camera, a mobile phone, a tablet computer, a display, a television, and a vehicle-mounted display terminal.

The display apparatus includes the display panel provided in any one of the above embodiments. Therefore, the display apparatus has all the beneficial effects of the display panel.

It should be understood that, in the embodiments of the present application, “B corresponding to A” means that B is associated with A and B can be determined based on A. It should also be understood that determining B based on A does not mean determining B based on only A, and B may also be determined based on A and/or other information.

The foregoing descriptions are merely specific implementations of the present application, but are not intended to limit the scope of protection of the present application. Any equivalent modification or replacement readily determined within the scope disclosed in the present application shall fall within the scope of protection of the present application. Therefore, the scope of protection of the present application shall be subject to the scope of protection of the claims.

What is claimed is:

1. A display panel, comprising:
a plurality of pixel circuits and a plurality of light-emitting element groups, one light-emitting element group comprising N light-emitting elements, and all first electrodes of the N light-emitting elements electrically connected to an output terminal of the same pixel circuit;
wherein the N light-emitting elements are located in different rows and emit light in different time periods within one frame, and N is an integer greater than 1.

2. The display panel according to claim 1, wherein
a plurality of second electrodes of the N light-emitting elements in the same light-emitting element group are connected to different power lines.

3. The display panel according to claim 1, wherein a working process of the display panel within one frame comprises M subframes, one of the N light-emitting elements emits light in one subframe, and the N light-emitting elements sequentially emit light respectively in the M subframes, wherein M=N.

4. The display panel according to claim 3, wherein
one light-emitting element group comprises two light-emitting elements, wherein the two light-emitting elements are located in two adjacent rows and the same column, or the two light-emitting elements are located in two adjacent rows and two adjacent columns.

5. The display panel according to claim 4, wherein
one subframe is used as one time period, and the M subframes comprise a first time period, a second time period, . . . , and an M^{th} time period; and in the case of M=2,
the two light-emitting elements located in two adjacent rows and the same column emit light of the same color, wherein
within the first time period, the light-emitting element located in an odd-numbered row emits light; and within the second time period, the light-emitting element located in an even-numbered row emits light.

6. The display panel according to claim 4, wherein
one subframe is used as one time period, and the M subframes comprise a first time period, a second time period, . . . , and an M^{th} time period; and in the case of M=2,
the two light-emitting elements located in two adjacent rows and the same column emit light of the same color, wherein
within the first time period, the light-emitting element located in both an odd-numbered row and an odd-numbered column emits light, and the light-emitting element located in both an even-numbered row and an even-numbered column emits light; and within the second time period, the light-emitting element located in both an odd-numbered row and an even-numbered column emits light, and the light-emitting element located in both an even-numbered row and an odd-numbered column emits light.

7. The display panel according to claim 4, wherein
one subframe is used as one time period, and the M subframes comprise a first time period, a second time period, . . . , and an M^{th} time period; and in the case of M=2,
the two light-emitting elements located in two adjacent rows and two adjacent columns emit light of different colors, wherein within the first time period, the light-emitting element located in an odd-numbered row emits light; and within the second time period, the light-emitting element located in an even-numbered row emits light.

8. The display panel according to claim 3, wherein
one light-emitting element group comprises three light-emitting elements, wherein the three light-emitting elements are located in three sequentially adjacent rows and the same column, or the three light-emitting elements are located in three sequentially adjacent rows and three sequentially adjacent columns.

9. The display panel according to claim 8, wherein
one subframe is used as one time period, and the M subframes comprise a first time period, a second time period, a third time period, . . . , and an M^{th} time period; and in the case of M=3,
the three light-emitting elements located in three sequentially adjacent rows and the same column emit light of the same color, wherein
within the first time period, the light-emitting element in a (1+3k)^{th} row emits light; within the second time period, the light-emitting element in a (2+3k)^{th} row emits light; and within the third time period, the light-emitting element in a (3+3k)^{th} row emits light, wherein k is an integer greater than or equal to 0.

10. The display panel according to claim 8, wherein
one subframe is used as one time period, and the M subframes comprise a first time period, a second time period, a third time period, . . . , and an M^{th} time period; and in the case of M=3,
the three light-emitting elements located in three sequentially adjacent rows and three sequentially adjacent columns emit light of different colors, wherein within the first time period, the light-emitting element in a (1+3k)^{th} row emits light, within the second time period, the light-emitting element in a (2+3k)^{th} row emits light, and within the third time period, the light-emitting element in a (3+3k)^{th} row emits light, wherein k is an integer greater than or equal to 0.

11. The display panel according to claim 3, wherein one light-emitting element group comprises three light-emitting elements, wherein the three light-emitting elements are located in three sequentially adjacent rows and the same column, and the three light-emitting elements emit light of different colors.

12. The display panel according to claim 11, wherein the light-emitting element groups in odd-numbered columns are arranged in parallel, the light-emitting element groups in even-numbered columns are arranged in parallel, and the light-emitting element groups in odd-numbered columns and even-numbered columns are staggered.

13. The display panel according to claim 12, wherein three adjacent light-emitting elements that emit light of different colors constitute one light-emitting unit, wherein one light-emitting unit comprises a first-color light-emitting element, a second-color light-emitting element, and a third-color light-emitting element, in the same light-emitting unit, the third-color light-emitting element is located in a separate column and the first-color light-emitting element and the second-color light-emitting element are located in the same column, and the light-emitting units are arranged in an array.

14. The display panel according to claim 13, wherein one subframe is used as one time period, and the M subframes comprise a first time period, a second time period, a third time period, . . . , and an M^{th} time period; and in the case of M=3,
within the first time period, the light-emitting elements in the light-emitting unit in a (1+3j)^{th} row emit light, within the second time period, the light-emitting elements in the light-emitting unit in a (2+3j)^{th} row emit light, and within the third time period, the light-emitting elements in the light-emitting unit in a (3+3j)^{th} row emit light, wherein j is an integer greater than or equal to 0.

15. The display panel according to claim 14, wherein a plurality of second electrodes of the light-emitting elements in the light-emitting units of the same row are connected to the same power line.

16. The display panel according to claim 13, wherein one subframe is used as one time period, and the M subframes comprise a first time period, a second time period, a third time period, . . . , and an M^{th} time period; and in the case of M=3,
within the first time period, the light-emitting elements in the light-emitting unit in a (1+3j)^{th} row and a (1+3i)^{th} column, the light-emitting elements in the light-emitting unit in a (2+3j)^{th} row and a (2+3i)^{th} column, and the light-emitting elements in the light-emitting unit in a (3+3j)^{th} row and a (3+3i)^{th} column emit light; within the second time period, the light-emitting elements in the light-emitting unit in the (1+3j)^{th} row and the (2+3i)^{th} column, the light-emitting elements in the light-emitting unit in the (2+3j)^{th} row and the (3+3i)^{th} column, and the light-emitting elements in the light-emitting unit in the (3+3j)^{th} row and the (1+3i)^{th} column emit light; and within the third time period, the light-emitting elements in the light-emitting unit in the (1+3j)^{th} row and the (3+3i)^{th} column, the light-emitting elements in the light-emitting unit in the (2+3j)^{th} row and the (1+3i)^{th} column, and the light-emitting elements in the light-emitting unit in the (3+3j)^{th} row and the (2+3i)^{th} column emit light, wherein i is an integer greater than or equal to 0, and j is an integer greater than or equal to 0.

17. A driving method for a display panel, wherein the display panel comprises a plurality of pixel circuits and a plurality of light-emitting element groups, one light-emitting element group comprising N light-emitting elements, and all first electrodes of the N light-emitting elements electrically connected to an output terminal of the same pixel circuit;
wherein the N light-emitting elements are located in different rows and emit light in different time periods within one frame, wherein N is an integer greater than 1; and
the driving method comprises:
controlling the N light-emitting elements located in different rows to emit light in different time periods within one frame.

18. The driving method for the display panel according to claim 17, wherein the driving method further includes:
within the first time period, controlling the light-emitting element located in an odd-numbered row to emit light, and within the second time period, controlling the light-emitting element located in an even-numbered row to emit light.

19. The driving method for the display panel according to claim 18, wherein the driving method further includes:
within the first time period, controlling the light-emitting element located in both an odd-numbered row and an odd-numbered column to emit light, and controlling the light-emitting element located in both an even-numbered row and an even-numbered column to emit light; and within the second time period, controlling the light-emitting element located in both an odd-numbered row and an even-numbered column to emit light, and controlling the light-emitting element located in an even-numbered row and an odd-numbered column to emit light.

20. The driving method for the display panel according to claim 19, wherein the driving method further includes:
within the first time period, controlling the light-emitting element in a (1+3k)^{th} row to emit light; within the second time period, controlling the light-emitting element in a (2+3k)^{th} row to emit light; and within the third time period, controlling the light-emitting element in a (3+3k)^{th} row to emit light.
